(19) United States
(12) Patent Application Publication
(10) Pub. No.: US 2022/0049079 A1
(43) Pub. Date: Feb. 17, 2022

(54) DRY POWDER BLENDS OF AMORPHOUS PERFLUORINATED POLYMERS, METHODS OF MAKING THE SAME, AND ARTICLES DERIVED FROM THE DRY POWDER BLENDS

(71) Applicant: 3M INNOVATIVE PROPERTIES COMPANY, St. Paul, MN (US)

(72) Inventors: Tatsuo Fukushi, Woodbury, MN (US); Klaus Hintzer, Kastl (DE); Florian D. Jochum, Ingelheim (DE); Michael H. Mitchell, Woodbury, MN (US); Tho Q. Nguyen, Bloomington, MN (US); Peter J. Scott, Stillwater, MN (US); Allen M. Sohlo, Lindstrom, MN (US); Yuta Suzuki, Kanagawa (JP); Karl D. Weilandt, Afton, MN (US); Steffen Vowinkel, Mühldorf am Inn (DE)

(21) Appl. No.: 17/413,127

(22) PCT Filed: Dec. 19, 2019
(86) PCT No.: PCT/US2019/067411

§ 371 Date: Jun. 11, 2021

Related U.S. Application Data
(60) Provisional application No. 62/782,380, filed on Dec. 20, 2018.

(51) Int. Cl. C08L 27/20; C08F 214/26; C08L 27/18

(52) U.S. Cl. CPC C08L 27/20; C08F 214/262; C08L 2207/53; C08L 2205/025; C08L 27/18

(57) ABSTRACT

Described herein is a method of making a curable perfluoroelastomer, wherein the curable perfluoroelastomer comprises particles of a semi crystalline fluoropolymer, wherein the semi crystalline fluoropolymer is a TFE copolymer comprising no more than 1 wt % of at least one additional fluorinated monomer. The method comprises: (a) obtaining an amorphous perfluoropolymer and the particles of the semi crystalline fluoropolymer; and (c) dry blending the amorphous perfluoropolymer and the particles to form a curable perfluoroelastomer.

### TECHNICAL FIELD

A dry powder blend comprising amorphous perfluoropolymers and semi crystalline fluoropolymer particles are disclosed. Such blends can be used to make a filled perfluoroelastomer, which can have improved plasma resistance and/or temperature stability.

### SUMMARY

There is a desire to identify a filled perfluorinated elastomeric composition, which has improved properties such as flexibility, heat resistance, and/or plasma resistance.

In one aspect, a dry powder blend is disclosed. The dry powder blend comprising (i) an amorphous perfluoropolymer comprising a cure site selected from the group consisting of —CN, —I, and —Br, and (ii) a plurality of semi crystalline fluoropolymer particles, wherein the semi crystalline fluoropolymer particles comprise a tetrafluoroethylene copolymer comprising no more than 1 wt % of at least one additional fluorinated monomer, wherein the semi crystalline fluoropolymer particles (i) have an melt flow index (MFI, at 372° C. with 2.16 kg) of less than 50 g/10 min or (ii) are not melt processible and have a standard specific gravity (SSG) of less than 2.200.

In another aspect, a curable perfluoropolymer composition is disclosed comprising a homogeneous blend of an amorphous perfluoropolymer particles and semi crystalline fluoropolymer particles, wherein the semi crystalline fluoropolymer particles comprise a tetrafluoroethylene (TFE) copolymer comprising no more than 1 wt % of at least one additional fluorinated monomer, wherein the semi crystalline fluoropolymer particles (a) have an MFI (372° C. with 2.16 kg) of less than 50 g/10 min or (b) are not melt processible and have an SSG of less than 2.200.

In another aspect, a cured perfluoroelastomer is disclosed comprising a perfluoropolymer filled with semi crystalline fluoropolymer particles, wherein the semi crystalline fluoropolymer particles comprise a TFE copolymer comprising no more than 1 wt % of at least one additional fluorinated monomer, wherein the semi crystalline fluoropolymer particles (a) have an MFI (372° C. with 2.16 kg) of less than 50 g/10 min or (b) are not melt processible and have an SSG of less than 2.200.

In yet another aspect, a method of making a curable perfluoroelastomer is disclosed, the method comprising:

(a) obtaining (i) an amorphous perfluoropolymer and (ii) particles of a semi crystalline fluoropolymer of TFE copolymer comprising no more than 1 wt % of at least one additional perfluorinated monomer;
(b) contacting the amorphous perfluoropolymer with the semi-crystalline particles; and
(c) dry blending the amorphous perfluoropolymer and the particles to form a curable perfluoroelastomer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups;

“cure site” refers to functional groups, which may participate in crosslinking;

“interpolymerized” refers to monomers that are polymerized together to form a polymer backbone;

“monomer” is a molecule which can undergo polymerization which then form part of the essential structure of a polymer; and

“polymer” refers to a macrostructure comprising repeating interpolymerized monomeric units.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

The present application is directed toward amorphous perfluorinated polymers, which are used in making perfluorinated elastomers. Perfluorinated elastomers are used in a wide variety of applications in which severe environments are encountered, specifically end uses where exposure to high temperatures and aggressive chemicals occur. In the semiconductor industry, perfluorinated elastomers are used in processes that require resistance to NF₃ plasma. However, this industry has stringent requirements on material purity especially around metal ions.

High fluorine content polymers can be used as fillers to provide the base polymer with improved performance (such as thermal stability, plasma resistance, etc.). PTFE and PFA polymers are both high fluorine content polymers. Traditionally, PFA (perfluoroalkoxy copolymers) polymers have been used as a filler in perfluoroelastomeric compositions for semiconductor use because PFA is a thermoplastic resin, which can be melt-processed, making it easy to work it.

Although the incorporation of PTFE (TFE homopolymer) would be ideal to add to the amorphous perfluoropolymer, since it has excellent thermal and chemical stability, as shown in the Example Section, PTFE has a tendency to fibrillate, causing a rough appearance in the final product due to, for example, difficulties in milling, and the non-homogeneous incorporation of the PTFE.

Modified PTFE is a TFE polymer comprising such a small concentration of comonomer that the polymer remains non-melt processable, typically comprising no more than 1 wt % of at least one additional fluorinated monomer. Thus, these materials can be dry blended into the base polymer. In at least some embodiments, under certain shear conditions these materials can fibrillate and/or deleteriously agglomerate.

In the present disclosure, it has been discovered that when dry blending particles of modified PTFE of a specific type with an amorphous perfluoropolymer, can result in a filled perfluoropolymer gum that has improved properties.

Semi Crystalline Fluoropolymer Particles

The particles of the present disclosure are a semi crystalline fluoropolymer of modified PTFE.

Modified PTFE is a polymer of tetrafluoroethylene modified with minor amounts, e.g., no more than 1, 0.5, 0.1, 0.05 or even 0.01 wt % of another fluorinated monomer. Exemplary fluorinated monomers include a perfluorinated ether of the formula

R_{f}—O—(CF₂)ₘCF=CF₂

wherein m is 0 or 1 and Rf represents a perfluoroalkyl residue containing from at least 1 carbon atoms which may be interrupted by at least one in-chain oxygen atom (i.e., ether linkage). Exemplary unsaturated fluorinated ether monomers include perfluoro(2-propoxypropyl vinyl) ether (PPVE-2), perfluoro(methyl vinyl) ether (PMVE), perfluoro(ethyl vinyl) ether (PEVE), perfluoro(3-methoxy-n-propyl vinyl) ether (MV-31), perfluoro(2-methoxy-ethyl vinyl) ether, perfluoro(n-propyl vinyl) ether (PPVE-1), perfluoro(methyl allyl) ether (MA-1), perfluoro(ethyl allyl) ether (MA-2), perfluoro(n-propyl allyl) ether (MA-3), perfluoro(n-butyl allyl) ether (MA-4), CF₃—O—(CF₂)₃—O—CF₂—CF═CF₂ (MA31) and F₃C—(CF₂)₂—O—CF(CF₃)—CF₂—O—CF(CF₃)—CF₂—O—CF═CF₂ (PPVE-3).

In one embodiment, the modified PTFE is modified with perfluorinated vinylethers or perfluorinated allylethers to achieve a low deformation under load. In one embodiment, the modified PTFE is modified with minor amounts of perfluorinated allyl ether monomers.

In one embodiment, the semi crystalline fluoropolymer particles comprise a group, for example a nitrile, bromine, or iodine sites, which can interact (for example bind) with the amorphous perfluoropolymer particles. Such groups may be introduced into the semi crystalline fluoropolymer via a chain transfer agent or cure sites monomer used during polymerization.

In one embodiment, the semi crystalline fluoropolymer particle is a random co-polymer made by copolymerizing tetrafluoroethylene with a different fluorinated monomer, such a perfluorinated allyl ether.

In another embodiment, the semi crystalline fluoropolymer particle is a core-shell particle comprising a core of one composition (such as TFE homopolymer or TFE copolymer) and a shell of a different composition (for example a shell derived from different monomers or a different concentration of monomers than the core). In the instance of a core-shell particle, typically the core has an average diameter of at least 10, 25, or even 40 nm and at most 100, 125, or even 150 nm. The shell may be thick or thin. For example, in one embodiment, the outer shell is a TFE copolymer, having a thickness of at least 100, or even 125 nm and at most 200 nm. In another embodiment, the outer shell is a TFE copolymer having a thickness of at least 1, 2, or even 5 nm and at most 15, or even 20 nm. Exemplary modified PTFE core-shell particles have a shell derived from a perfluorinated vinyl ether, a perfluorinated allyl ether, and/or a cure-site containing monomer. The overall content of the modifier (for example perfluorinated vinyl ether, perfluorinated allyl ether, and cure-site containing monomer) is, on average, less than 1, 0.5, or even 0.2 wt % of the weight of the particle. In one embodiment, the content of the second monomer in the semi crystalline fluoropolymer particle is about 1000 parts per million.

The above-mentioned semi crystalline fluoropolymers particles can be made using techniques known in the art, for example, by aqueous emulsion polymerization with or without fluorinated emulsifiers; followed by coagulation of the latex, agglomeration and drying to harvest the semi crystalline fluoropolymers particles.

In one embodiment, the semi crystalline fluoropolymer fibrillates upon shear.

The semi crystalline fluoropolymer particles may be melt processible or not melt processible.

The melt-processible semi crystalline fluoropolymer particles are those materials having a low molecular weight. Such low molecular weight polymers have an MFI (melt flow index) at 372° C. and 2.16 kg of load of less than 50, 45, or even 40 g/10 min. Even a material having an MFI at 372° C. and 21.6 kg of less than 5 g/10 min, less than 1 g/10 min, less than 0.5 g/10 min is considered melt-processible.

In one embodiment, the semi crystalline fluoropolymer has a melting point after a second heating of greater than 320, or even 330° C. As a solid, modified PTFE and PTFE can exist in different phases that can be measured by thermo-mechanical analysis. For example, at around 19° C. and atmospheric pressure, PTFE goes from triclinic crystal II to hexagonal crystal IV, and at around 32° C. and atmospheric pressure, from hexagonal crystal IV to pseudohexagonal crystal I as described in Sperati, C.A., Adv. Polym. Sci., 2: 465, 1961. Such physical changes occur at phase transition temperatures, which can be indicated by peaks when monitoring the heat flow versus temperature for the solid material using DMA (dynamic mechanical analysis). In one embodiment, the semi crystalline fluoropolymer has a phase transition temperature of greater than 15, 16, or even 17° C. and at most 20, 21, or even 22° C.

The semi crystalline fluoropolymer particles having a higher molecular weight fluoropolymer are essentially non-melt processible (having a melt flow index of less than 0.1, 0.05, or even 0.001 g/10 min at 372° C., 21.6 kg). The molecular weight of these non-melt-processible polymers cannot be measured by conventional techniques. Thus, an indirect method that correlates with molecular weight, such as standard specific gravity (SSG) is used. The lower the SSG value, the higher the average molecular weight. The SSG of the PTFE of the present disclosure, is at most 2.200, 2.190, 2.185, 2.180, 2.170, 2.160, 2.157, 2.150, 2.145, or even 2.130 g/cm³ as measured according to ASTM D4895-04. Exemplary non melt-processible semi crystalline fluoropolymer particles include core-shell particles derived perfluorinated vinyl or allyl ethers as a modifier in the shell and/or the core, and random copolymer particles derived from a nitrile-containing cure-site monomer.

Amorphous Perfluoropolymer

The amorphous perfluoropolymer is a macromolecule comprising interpolymerized repeating divalent monomeric units, wherein each of the monomeric units is perfluorinated (in other words, the monomeric unit comprises at least one C—F bond and no C—H bonds). The perfluorinated polymer may comprise terminal groups that are not perfluorinated based on the initiator and/or chain transfer agent used as is known in the art.

The perfluorinated polymer is obtained generally by polymerizing one or more types of perfluorinated monomers such as perfluorinated olefins and perfluorinated olefins comprising ether linkages. Exemplary perfluorinated monomers include: tetrafluoroethylene, hexafluoropropylene, pentafluoropropylene, trifluorochloroethylene, perfluoro ether monomer such as perfluoro vinyl ether monomers and perfluoro allyl ether monomers.

Examples of perfluoro ether monomers that can be used in the present disclosure include those that correspond to the formula: CF₂═CF(CF₂)ₘ—O—R_{f} wherein m is 0 or 1 and R_{f} represents a perfluorinated aliphatic group that may contain no, one or more oxygen atoms and up to 12, 10, 8, 6 or even 4 carbon atoms.

Exemplary perfluorinated vinyl ether monomers correspond to the formula: CF₂═CFO(R^{a}_{f}O)ₙ (R^{b}_{f}O)ₘR^{c}_{f} wherein R^{a}_{f} and R^{b}_{f} are different linear or branched perfluoroalkylene groups of 1-6 carbon atoms, in particular 2-6 carbon atoms, m and n are independently 0-10 and R^{c}_{f} is a perfluoroalkyl group of 1-6 carbon atoms. Specific examples of perfluorinated vinyl ethers include perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, and CF₃—(CF₂)₂—O—CF(CF₃)—CF₂—O—CF(CF₃)—CF₂—O—CF═CF₂.

Examples of perfluoroallyl ether monomers that can be used in the present disclosure include those that correspond to the formula: CF₂═CF(CF₂)—O—R_{f} wherein R_{f} represents a perfluorinated aliphatic group that may contain no, one or more oxygen atoms and up to 10, 8, 6 or even 4 carbon atoms. Specific examples of perfluorinated allyl ethers include: CF₂═CF—CF₂—O—(CF₂)ₙF wherein n is an integer from 1 to 5, and CF₂═CF—CF₂—O—(CF₂)ₓ—O—(CF₂)_{y}—F wherein x is an integer from 2 to 5 and y is an integer from 1 to 5. Specific examples of perfluorinated allyl ethers include perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and combinations thereof.

In the present disclosure, the perfluorinated polymer may be polymerized in the presence of a chain transfer agent and/or cure site monomers to introduce cure sites such as I, Br, and/or CN, into the fluoropolymer.

Exemplary chain transfer agents include: an iodo-chain transfer agent, a bromo-chain transfer agent, or a chloro-chain transfer agent. For example, suitable iodo-chain transfer agent in the polymerization include the formula of RIₓ, where (i) R is a perfluoroalkyl or chloroperfluoroalkyl group having 3 to 12 carbon atoms; and (ii) x=1 or 2. The iodo-chain transfer agent may be a perfluorinated iodo-compound, such as I(CF₂)ₙ—O—(CF₂)ₘ—I, wherein n and m are integers independently selected from 1, 2, 3, 4, 5, 6, 7, 8, 9, 10, or even 12. Exemplary iodo-perfluoro-compounds include 1,3-diiodoperfluoropropane, 1,4-diiodoperfluorobutane, 1, 6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutane, and mixtures thereof. In some embodiments, the bromine is derived from a brominated chain transfer agent of the formula: RBrₓ, where (i) R is a perfluoroalkyl or chloroperfluoroalkyl group having 3 to 12 carbon atoms; and (ii) x=1 or 2. The chain transfer agent may be a perfluorinated bromo-compound.

In one embodiment, the cure sites may be derived from one or more monomers of the formula: (a) CX₂═CX(Z), wherein: (i) X each is independently H or F; and (ii) Z is I, Br, R_{f}—U wherein U═I or Br and R_{f}=a perfluorinated alkylene group optionally containing O atoms or (b) Y(CF₂)_{q}Y, wherein: (i) Y is Br or I or Cl and (ii) q=1-6. In addition, non-fluorinated bromo- or iodo-olefins, e.g., vinyl iodide and allyl iodide, can be used. In some embodiments, the cure site monomers are derived from one or more compounds selected from the group consisting of CF₂═CFCF₂I, ICF₂CF₂CF₂CF₂I, CF₂═CFCF₂CF₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CF₂═CFCF₂Br, CF₂═CFOCF₂CF₂Br, CF₂═CFCl, CF₂═CFCF₂Cl, and combinations thereof.

In another embodiment, the cure site monomers comprise nitrogen-containing cure moieties. Useful nitrogen-containing cure site monomers include nitrile-containing fluorinated olefins and nitrile-containing fluorinated vinyl ethers, such as: perfluoro(8-cyano-5-methyl-3,6-dioxa-1-octene); CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN or CF₂═CFO[CF₂CF(CF₃)O]_{q}(CF₂)_{y}OCF(CF₃)CN wherein q is an integer from 0 to 4 and y is an integer from 0 to 6; or CF₂═CF[OCF₂CF(CF₃)]ᵣO(CF₂)ₜCN wherein r is 1 or 2, and t is an integer from 1 to 4; and derivatives and combinations of the foregoing. Examples of a nitrile-containing cure site monomer include CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF₂CF₂OCF(CF₃)CN, CF₂═CFOCF₂CF(CF₃)OCF₂CF₂CN; and combinations thereof.

In one embodiment, the amorphous perfluoropolymer has a glass transition temperature of less than 20, 10, 5, 0, −5, −10, or even −15° C.

Blending

In the present disclosure, the particles of the semi crystalline fluoropolymer (i.e., modified PTFE) and the amorphous perfluoropolymer are combined using standard mixing equipment for dry blending components. Exemplary mixing techniques include, for example, kneading with use of a twin roll for rubber, a pressure kneader or a Banbury mixer. As used herein dry blending is meant blending together ingredients which contain little, if any, water or solvent, as opposed to latex, liquid dispersion or solution blending wherein significant quantities or water or solvent are present. Optionally, the dry blending process may be done in two steps wherein the amorphous perfluoropolymer and the particles are pre-blended prior to the introduction of the curative. In one embodiment, the average primary particle size of the particles is at least 50, 75, 100, or even 125 nm and at most 200, 250, 300, 400, or even 500 nm. These primary particles may be agglomerated together forming an agglomerate having an average diameter of at least 5, 10, 25, 50, 75, 100, or even 125 micrometers and at most 500, 600, 800, or even 1000 micrometers.

In one embodiment, the curable fluoropolymer blend comprises at least 5, 10 or even 15%; and at most 20, 25, 30, or even 35% by weight of the semi crystalline fluoropolymer. Optionally, additional fillers and/or cure catalyst may be added during the blend.

In one embodiment, the blend has a melting temperature of greater than 310, 312, 315, 318, or even 320° C. In one embodiment, the blend has a melting temperature of less than 329, 327, 325, or even 323° C.

In one embodiment, the polymer blend has a decomposition temperature of higher than 500, 501, 502, 503, 504, or even 505° C. In one embodiment, the polymer blend has a decomposition temperature of less than 510, 509, 508, 507, or even 506° C.

In one embodiment, the polymer blend has at least one recrystallization temperature that is less than 310, 309, 308, 307, or even 305° C.

A curing agent may be blended with or subsequently added to the amorphous perfluoropolymer comprising the particles to cure the amorphous perfluoropolymer to generate the perfluoroelastomer.

Generally, the effective amount of the curing agent in the curable composition, which may include more than one curing agent, is at least 0.1, 0.5, or even 1 wt %; and below 10, 8, 6, or even 5 wt %, although higher and lower amounts of curing agent may also be used.

Curing agents can include curatives and cure catalysts. Curing agents can include those known in the art including: peroxides, triazine forming curing agent, benzimidazole forming curing agent, benzoxazole forming curing agent, adipates, and acetates, among others. These curing agents may be used by themselves or in combination with another curing agent or curing agents.

Peroxides may also be utilized as curing agents. Useful peroxides are those which generate free radicals at curing temperatures. A dialkyl peroxide or a bis (dialkyl peroxide), which decomposes at a temperature above 50° C. is especially preferred. In many cases it is preferred to use a di-tertiarybutyl peroxide having a tertiary carbon atom attached to peroxy oxygen. Peroxides selected may include: benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, O,O′-1,3-propanediyl OO,OO′-bis(1,1-dimethylethyl) ester, tert-butylperoxy benzoate, t-hexyl peroxy-2-ethylhexanoate, t-butyl peroxy-2-ethylhexanoate, di(4-methylbenzoyl) peroxide, laurel peroxide and cyclohexanone peroxide. Other suitable peroxide curatives are listed in U.S. Pat. No. 5,225,504 (Tatsu et al.). The amount of peroxide curing agent used generally will be 0.1 to 5, preferably 1 to 3 parts by weight per 100 parts of amorphous perfluoropolymer.

In one embodiment, the curing agent may be selected from triazine forming cure networks. Such curing agents include: an organotin compounds (such as propargyl-, triphenyl- and allenyl-, tetraalkyl-, and tertraaryl tin curatives); ammonia generating compounds (e.g., see U.S. Pat. No. 6,281,296; ammonium salts, such as ammonium perfluorooctanoate (e.g., see U.S. Pat. No. 5,565,512); and amidines (e.g., see U.S. Pat. No. 6,846,880); imidates (e.g., see U.S. Pat. No. 6,657,013), metalamine complexes (e.g., see U.S. Pat. No. 6,657,012), and hydrochloric salts (e.g., see U.S. Pat. No. 6,794,457).

In another embodiment, the fluoropolymer blends can be cured using one or more peroxide curatives along with the ammonia generating catalysts. The cure catalyst may comprise for example, a first component and a second component wherein the first component is represented by R′C(CF₂R)O⁻Q⁺, where Q⁺ is a non-interfering organophosphonium, organosulfonium, or organoammonium cation; each R independently represents H, halogen, a hydrocarbyl group or a halogenated hydrocarbyl group, wherein at least one carbon atom of the hydrocarbyl group may be further substituted with one or more heteroatoms selected from N, O and S; R′ represents H, a hydrocarbyl group or a halogenated hydrocarbyl group, wherein at least one carbon atom of the hydrocarbyl group may be further substituted with one or more heteroatoms selected from N, O and S; or any two of R or R′ may together form a divalent hydrocarbylene group, wherein at least one carbon atom of the hydrocarbylene group may be further substituted by one or more heteroatoms selected from N, O, and S, and the second component is represented by [N≡CCFR″]_{b}Z, wherein each R″ independently represents F or CF₃; b represents any positive integer; and Z represents a b-valent organic moiety free of interfering groups. See e.g., U.S. Pat. No. 7,294,677. Examples include: a reaction product of CF₃OCF₂CF₂CN and tetrabutylphosphonium 2-(p-toluyl)-1,1,1,3,3,3-hexafluoroisopropoxide; a reaction product of CF₃OCF₂CF₂CN and tetrabutylammonium 2-(p-toluyl)-1,1,1,3,3,3-hexafluoroisopropoxide; and combinations thereof.

A catalyst comprising one or more ammonia-generating compounds may be used to cause curing. Ammonia-generating compounds include compounds that are solid or liquid at ambient conditions but that generate ammonia under conditions of cure. Such compounds include, for example, hexamethylene tetraamine (urotropin), dicyan diamid, and metal-containing compounds of the formula: A^{w+}(NH₃)ᵥY^{w-}, where A^{w+} is a metal cation such as Cu²⁺, Co²⁺, Co³⁺, Cu⁺, Ni²⁺; w is equal to the valence of the metal cation; Y^{w-} is a counterion, typically a halide, sulfate, nitrate, acetate or the like; and v is an integer from 1 to about 7.

Also useful as ammonia-generating compounds are substituted and unsubstituted triazine derivatives such as those of the formula:

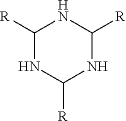

where R is a hydrogen or a substituted or unsubstituted alkyl, aryl, or aralkyl group having from 1 to about 20 carbon atoms. Specific useful triazine derivatives include: hexahydro-1,2,5-s-triazine and acetaldehyde ammonia trimer.

In one embodiment, the curing agent may be selected from the following:

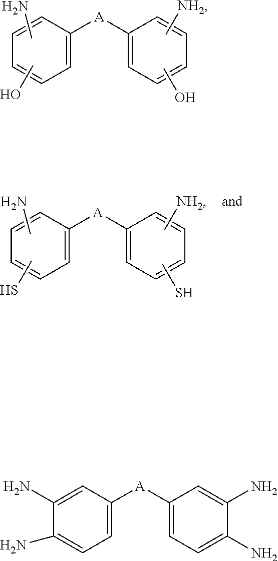

where A is SO₂, O, CO, alkyl of 1-6 carbon atoms, perfluoroalkyl of 1-10 carbon atoms, or a carbon-carbon bond linking the two aromatic rings, such as those disclosed in U.S. Pat. No. 6,114,452. For example, a useful curing agent may include bis(aminophenols), such as 2,2-bis[3-amino-4-hydroxyphenyl] hexafluoropropane; bis(aminothiophenols), such as 4,4′-sulfonylbis(2-aminophenol); and tetraamines, such as 3,3′ diaminobenzidine; and 3,3′, 4,4′-tetraaminobenzophenone.

Bisamidrazone compounds for example, 2,2-bis(4-carboxyphenyl)hexafluoropropane bisamidrazone, and bisamidrazones and bisamidoximes may also be used as curing agents.

In another embodiment, curing agents (or precursors thereof) of the following formula may be used:

{R(A)ₙ}⁽⁻ⁿ⁾{QR′ₖ⁽⁺⁾}ₙ

wherein R is a C₁-C₂₀ alkyl or alkenyl, C₃-C₂₀ cycloalkyl or cycloalkenyl, or C₆-C₂₀ aryl or aralkyl, which may be nonfluorinated, partially fluorinated, or perfluorinated or hydrogen. R can contain at least one heteroatom, i.e., a non-carbon atom such as O, P, S, or N. R can also be substituted, such as where one or more hydrogen atoms in the group is replaced with Cl, Br, or I. {R(A)ₙ}⁽⁻ⁿ⁾ is an acid anion or an acid derivative anion, n is the number of A groups in the anion. A is an acid anion or an acid derivative anion, e.g., A can be COO anion, SO₃ anion, SO₂ anion, SO₂NH anion, PO₃ anion, CH₂OPO₃ anion, (CH₂O)₂PO₂ anion, C₆H₄O anion, OSO₃ anion, O anion (in the cases where R is hydrogen, aryl, or alkylaryl),

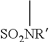

anion,

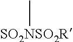

anion, and

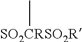

anion. R′ is defined as R (above), and a particular selection for R′ may be the same or different from the R attached to A, and one or more A groups may be attached to R. Q is phosphorous, sulfur, nitrogen, arsenic, or antimony, and k is the valence of Q. When Q is nitrogen and the only fluoropolymer in the composition consists essentially of a terpolymer of tetrafluoroethylene, a perfluorovinylether, and a perfluorovinylether cure site monomer comprising a nitrile group, not every R′ is H, and k is one greater than the valence of Q. (See, e.g., U.S. Pat. Nos. 6,890,995 and 6,844,388). Examples may include bistetrabutylphosphonium perfluoroadipate, tetrabutyl phosphonium acetate, and tetrabutyl phosphonium benzoate.

Other curing agents may include: bis-aminophenols (e.g., see U.S. Pat. Nos. 5,767,204 and 5,700,879); organometallic compounds (e.g., see U.S. Pat. No. 4,281,092); bis-amidooximes (e.g., see U.S. Pat. No. 5,621,145); aromatic amino compounds; bisamidrazones; bisamidoximes; and tetraphenyltin.

Depending on the cure site components present, it is also possible to use a dual cure system. For example, perfluorinated polymers having copolymerized units of nitrile-containing cure site monomers can be cured using a curing agent comprising a mixture of a peroxide in combination with organotin curative and a co-agent.

A co-agent (sometimes referred to as a co-curative) may be composed of a poly unsaturated compound which is capable of cooperating with the peroxide to provide a useful cure. The co-agent may be one or more of the following compounds: triallyl cyanurate; triallyl isocyanurate; tri(methylallyl) isocyanurate; tris(diallylamine)-s-triazine; triallyl phosphate; N,N-diallyl acrylamide; hexaallyl phosphoramide; N,N,N′,N′-tetraallyl malonamide; trivinyl isocyanurate; 2,4,6-trivinyl methyltrisiloxane; and tri(5-norbornene-2-methylene)cyanurate.

Other useful co-agents include the bis-olefins. (See e.g., EP 0661304 A1, EP 0784 064 and EP 0769521.)

After homogeneously blending the particles of the semi crystalline fluoropolymer (i.e., modified PTFE) and the amorphous fluoropolymer and optional other ingredients, the mixture may then be processed and shaped such as by extrusion or molding to form an article of various shapes such as sheet, a hose, a hose lining, an o-ring, a gasket, or a seal composed of the composition of the present disclosure. The shaped article may then be heated to cure the perfluoropolymer gum composition and form a cured elastomer article.

Pressing of the compounded mixture (i.e., press cure) is typically conducted at a temperature of about 120-220° C., preferably about 140-200° C., for a period of about 1 minute to about 15 hours, usually for about 1-15 minutes. A pressure of about 700-20,000 kPa, preferably about 3400-6800 kPa, is typically used in molding the composition. The molds first may be coated with a release agent and prebaked.

The vulcanizate can be post cured in an oven at a temperature of about 140-350° C., preferably at a temperature of about 200-330° C., for a period of about 1-24 hours or more, depending on the cross-sectional thickness of the sample. For thick sections, the temperature during the post cure is usually raised gradually from the lower limit of the range to the desired maximum temperature. In one embodiment, curing temperature is greater than 300° C. In one embodiment, curing temperature is higher than the melting point of the melting point of the semi crystalline fluoropolymer particles.

In one embodiment of the present disclosure, the composition comprising the perfluoroelastomer gum or the cured perfluoroelastomer is substantially free of a metal cations, in particular of Na, K, Mg, and Al cations, but generally of alkaline earth metal ions and alkali metal ions in general and may contain them in amounts of less than 20 ppm (parts per million) or less than 10 ppm or even less than 1 ppm. The level of alkaline- and alkaline-earth-ions (Na, K, Li, Ca, Mg, Ba) and Al may be individually below 1 ppm and in total below 4 ppm. Other ions like Fe, Ni, Cr, Cu, Zn, Mn, Co may be in total less than 4 ppm.

A particular advantage of the methods of the present disclosure is that blends of fluoroelastomers and particles can be prepared that have a low content of fluorinated emulsifier acids. Such blends may be particularly useful for applications in the semiconductor industry because not only a low metal content is required for such applications but also desirably no acids should leak out from the fluoropolymer materials to meet the high purity requirements in semiconductor processing and production. The perfluoroelastomers according to the present disclosure have very low amounts of fluorinated acids (for example, extractable C8-C14 alkanoic acids) and its salts, for example, less than 2000, 1000, 500, 100, 50, 25, or even 15 ppb (parts per billion) based on the weight of the polymer, which can be determined by extraction as described in U.S. Pat. No. 2019-0185599 (Hintzer et al.), herein incorporated by reference, wherein the fluorinated acid corresponds to the general formula:

Y—R_{f}—Z-M

wherein Y represents hydrogen, Cl or F; R_{f} represents a divalent linear or branched or cyclic perfluorinated or partially fluorinated saturated carbon chain having 8 to 14 carbon atoms; Z represents an acid group, for example a —COO⁻ or a —SO₃⁻ acid group, and M represents a cation including H⁺.

The blends comprising the amorphous perfluoropolymer and the particles of the semi crystalline fluoropolymer may be particularly useful for making seals or molds, in particular for an apparatus in the production or purification of semiconductors or products containing semiconductors including an etching apparatus and a vacuum evaporator. An etching apparatus includes a plasma etching apparatus, a reactive ion etching apparatus, a reactive ion beam etching apparatus, a sputtering etching apparatus, and an ion beam etching apparatus.

In one embodiment, the resulting perfluoroelastomer which was dry blended and comprised a cooling step (for example, cooling the semi crystalline fluoropolymer below its phase transition temperature, such as below 20, 10, 5 or even 0° C.) prior to incorporation, can result in a filled perfluoropolymer gum that has improved properties over the same perfluoroelastomer, which did not comprise a cooling step. For example, the perfluoroelastomers of the present disclosure may have improved plasma resistance, improved thermal stability, and/or improved flexibility.

Because of the stringent requirements related to using perfluoroelastomers in the semiconductor industry. Various test methods have been developed to predict whether or not the perfluoroelastomer article is suitable for use. One such test method is related to weight loss, where the perfluoroelastomer article is exposed to the plasma and the loss of weight is determined. In one embodiment, the perfluoroelastomer has a weight loss of less than 20, 10, 5, or even 1% when exposed to plasma treatment.

Ideally, the semi crystalline fluoropolymer particles should have good compatibility with amorphous perfluoropolymer to enable a filled perfluorinated elastomeric composition having good aesthetics (for example a smooth and/or non-fibrillated product).

In one embodiment, the blending of the semi crystalline fluoropolymer particles to the amorphous perfluoropolymer particles results in the blend having a decrease in the melting point of at least 1.5, 2.0, 2.5, 3.0, 4.0. 5.0, 6.0, 8.0, or even 10.0 as compared to the melting point of the semi crystalline fluoropolymer particles. In one embodiment, the blend comprising the semi crystalline fluoropolymer particles and the amorphous perfluoropolymer has a melting point of at least 310, 320, 322, 324, or even 326° C. In one embodiment, the blend comprising the semi crystalline fluoropolymer particles and the amorphous perfluoropolymer has a melting point of at most 325, 326, 327, 328, or even 329° C.

The stability of the semi crystalline fluoropolymer may be determined by analyzing the agglomerated blend using Thermogravimetry Analysis measuring the weight versus temperature. The derivative of this curve is then used to determine at what temperature the inflection occurs. The inflection point temperature can be interpreted as the starting temperature of degradation of the semi-crystalline fluoropolymer. In one embodiment, the blend comprising the semi crystalline fluoropolymer particles and the amorphous perfluoropolymer has an inflection temperature of higher than 500, 501, 502, 503, 504, or even 505° C. In one embodiment, the blend comprising the semi crystalline fluoropolymer particles and the amorphous perfluoropolymer has an inflection temperature of less than 510, 509, 508, 507, or even 506° C.

The recrystallization temperature refers to the temperature at which a semi crystalline polymer in the amorphous state crystallizes when cooled. Depending on the crystal states, the polymer may have one or more recrystallization points. In one embodiment, the blend comprising the semi crystalline fluoropolymer particles and the amorphous perfluoropolymer has at least one recrystallization temperature of less than 310, 309, 308, 307, or even 305° C.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used in this section: L=liters, mg=milligrams, g=grams, kg=kilograms, cm=centimeters, mm=millimeters, wt %=percent by weight, min=minutes, h=hours, d=days, NMR=nuclear magnetic resonance, ppm=parts per million, sccm=standard cubic centimeters, C=degrees Celsius, mTorr=milliTorr, RF=radio frequency, W=watts, mol=moles Abbreviations for materials used in this section, as well as descriptions of the materials, are provided in Table 1.

TABLE 1
Materials

| | |
|---|---|
| PFE A | A fluorine-containing copolymer |
| | of tetrafluoroethylene (TFE) and |
| | perfluoromethyl vinyl ether |
| | (PMVE) with 72.4 wt % fluorine |
| | content, 0.27 wt % CN content and |
| | Mooney Viscosity ML1 + 10 @ |
| | 121° C. of 95, available under the |
| | trade designation “3M DYNEON |
| | PFE 131TZ” from 3M Company, |
| | Maplewood, MN, USA. |
| PFE B | An amorphous perfluoropolymer |
| | prepared as described under |
| | Preparative Example PE-4. |
| TFM 2001Z | A modified polytetrafluoroethylene |
| | fine powder with average |
| | particle size 520 micrometer and |
| | SSG of 2.15 available under the |
| | trade designation “3M DYNEON |
| | TFM 2001Z” from 3M Company, |
| | Maplewood, MN, USA |
| PFA 6503NAZ | A fluorine-containing copolymer |
| | of tetrafluoroethylene (TFE) and |
| | perfluoropropyl vinyl ether (PPVE) |
| | having a melting point of 308° C. |
| | with an MFI of 3 (372° C./5 kg) |
| | and average particle size 30 |
| | micrometer, available under |
| | the trade designation “3M DYNEON |
| | PFA 6303 NAZ” from 3M Company, |
| | Maplewood, MN, USA |
| TF 2071Z | Tetrafluoroethylene homopolymer |
| | fine powder available under the |
| | trade designation “3M DYNEON |
| | TF 2071Z” from 3M Company, |
| | Maplewood, MN, USA |
| Fluoropolymer A | Core-shell particles prepared |
| | as described under Preparative |
| | Example 1 |
| Fluoropolymer B | Core-shell particles prepared |
| | as described under Preparative |
| | Example 2 |
| Fluoropolymer C | Core-shell particles prepared |
| | as described under Preparative |
| | Example 3 |
| Catalyst A | Perfluoromethoxypropyl amidine |
| | trifluoroacetate can be prepared as |
| | described for “Catalyst A” in |
| | U.S. Pat. No. 2008/0021148. |
| Emulsifier | CF₃—O—(CF₂)₃—O—CHF—CF₂—COON⁻H₄⁺, |
| | prepared as described for |
| | “Compound 1” in |
| | U.S. Pat. App. U.S. 2007/0015937 |

Specific Gravity

For Preparative Examples 2 and 3, the protocol of DIN EN ISO 12086-2:2006-05 was followed to determine specific gravity.

Particle Size Measurement for Dry Blend:

The particle size can be measured by laser diffraction methods according to ISO 13320 (2009).

Vinyl and Allyl Ether Comonomer Content

For the Preparative Example, which is melt-processible fluoropolymer particles, thin films of approximately 0.1 mm thickness were prepared by moulding the coagulated, dried polymer at 350° C. using a heated plate press. For the Preparative Examples, which are not melt-processible fluoropolymer particles, thin films of 0.3 to 0.4 mm thickness were prepared by cold compacting the polymer composition in a mould. These films were then scanned in nitrogen atmosphere using a Nicolet DX 510 FT-IR spectrometer. The OMNIC software (ThermoFisher Scientific, Waltham, Mass.) was used for data analysis. Herein the CF₂═CF—CF₂—O—CF₂—CF₂—CF₃ (MA-3) content, reported in units of weight %, was determined from an infrared band at 9991/cm and was calculated as 1.24×the ratio (factor determined by means of solid-state NMR) of the 9991/cm absorbance to the absorbance of the reference peak located at 23651/cm. The CF₂═CF—O—CF₂—CF₂—CF₃ (PPVE-1) content, reported in units of weight %, was determined from an infrared band at 9931/cm and was calculated as 0.95×the ratio of the 9931/cm absorbance to the absorbance of the reference peak located at 23651/cm.

Melt-Flow Index

For Preparative Example 1 (a melt-processible semi crystalline fluoropolymer), the melt-flow index (MFI), reported in g/10 min, was measured according to DIN EN ISO 1133-1:2012-03 at a support weight of either 2.16, 5.0, or 21.6 kg. The MFI was obtained with a standardized extrusion die of 2.1 mm diameter and a length of 8.0 mm. Unless otherwise noted, a temperature of 372° C. was applied.

### Preparative Example 1 (Fluoropolymer A)

An oxygen-free 40 L-kettle was charged with 27 kg deionized water, 390 g of a 30 wt % aqueous Emulsifier solution, 100 g PPVE-1 and 200 mbar Ethane (at 25° C.). Then the reactor was heated to 75° C. and TFE was charged until a pressure of 10 bar was reached. The polymerization was initiated by feeding 3.0 g ammonium persulfate (APS) (dissolved in 50 g deionized water). TFE was constantly fed at 10 bar (1 MPa) pressure. After 5.6 kg total TFE, 280 g PPVE-1 was fed into the reactor and additional 1 g APS was added. After 7.9 kg TFE, the polymerization was stopped. The latex had a solid content of 20.7 wt % and a d50 of 122 nm. The coagulated, dried polymer had a PPVE-1 content of 0.8 wt % and a MFI (372° C., 5 kg) of 18 g/10 min. The Tm of the fluoropolymer was determined as described above. The polymer had a Tm of 323° C. and a recrystallization point at 306° C. The dry powder had a d50 of 470 μm.

### Preparative Example 2 (Fluoropolymer B)

An oxygen-free 40 L-kettle was charged with 28 L of deionized water, 100 g of a 30 wt % aqueous Emulsifier solution, 0.9 g of a 10 wt % aqueous tert-butanol solution, 0.9 g of oxalic acid dihydrate and 82 g PPVE-1. The kettle was heated up to 40° C. and TFE was fed into the reactor to get 15 bar (1.5 MPa) pressure. The polymerization was initiated by adding 70 mg pure KMnO₄ (fed as 0.04 wt % aq. solution), another 70 mg KMnO₄ was added continuously over the whole time (133 min). After 7.7 kg TFE was added, a mixture of 50 g MV5CN CF₂═CF—O—(CF₂)₅—CN, 1 g Emulsifier and 50 g water was fed to the polymerization. After a total of 8.3 kg TFE was fed into the reactor the polymerization was terminated. The latex had a solid content of 22.5 wt %, d50 of 120 nm. The coagulated, dried polymer had an SSG of 2.146, PPVE content of 0.4 wt %, and a nitrile-signal at 2236 cm⁻¹ was visible. The Tm of the fluoropolymer was determined as described above, having a Tm of 328° C. and a recrystallization of 303° C. The dry powder had a d50 of 560 μm.

### Preparative Example 3 (Fluoropolymer C)

An oxygen-free 40 L-kettle was charged with 28 kg of deionized water, 100 g of a 30 wt % aqueous Emulsifier solution, 7 g of a 10 wt % aqueous solution of tert-butanol, 0.9 g of oxalic acid dihydrate and 50 g of MA-3 (C₃F₇—O—CF₂—CF═CF₂ available from Anles, St. Petersburg, Russia). The kettle was heated up to 40° C. and TFE was added to reach 15 bar (1.5 MPa). The polymerization was initiated by feeding 76 mg KMnO₄ (as 0.04 wt % aq. solution) to the reactor. During the whole runtime (160 min) another 40 mg KMnO₄ was added. A total of 8.3 kg of TFE was added. The final latex had a solid content of 22.5 wt %, d50 of 110 nm. The coagulated, dried polymer had a SSG of 2.137 and an MA-3 content of 0.06 wt %. The Tm of the fluoropolymer was determined as described above and has a Tm of 321° C. and a recrystallization point of 306° C. The dry powder had a d50 of 430 μm.

### Preparative Example 4

An oxygen-free 150 L kettle was charged with 105 kg deionized water, 2.8 kg of a 30 wt % aqueous Emulsifier solution, 56 g of ammonium chloride, 235 g ammonium nonafluorobutane-1-sulfinate (as a 34 wt % solution in water) and 214 g of a MV5CN preemulsion. The MV5CN preemulsion consists of 25 wt % MV5CN (available from Anles, St. Petersburg, Russia), 0.4 wt % Emulsifier (30 wt % aqueous solution) and 74.6 wt % water and is prepared by mixing with a homogenzier. Afterwards the kettle was heated to 65° C. and PMVE was charged until a pressure of 10 bar was reached, followed by TFE until 14 bar. The polymerization was initiated by feeding 890 g of a 20 wt % aqueous APS solution. PMVE and TFE was constantly fed to the reactor while 7.45 kg of the MV5CN preemulsion was added until a total amount of 26.3 kg TFE was added. After 295 min, in total 24.1 kg PMVE, 28.3 kg TFE was added and the polymerization was stopped. The latex had a solid content of 32.6 wt % and a d50 of 77 nm. The solid polymer showed a Mooney viscosity of 57 Mooney units and having about 52.4 wt % TFE, 43.7 wt % PMVE and 3.9 wt % CF₂═CFO(CF₂)₅CN.

### Examples 1 Through 7 and Comparative Examples 1 and 2

Perfluoroelastomer compounds were prepared using a 6 inch (15.24 cm) two roll mill by compounding the amorphous perfluoropolymer with the semi crystalline fluoropolymer, in amounts indicated in Tables 3 and 4. For Example 1 and Comparative Example 1, TFM 2001Z and PFA 6503NAZ were stored in a freezer at −20° C. for at least one day and then added to the band with continued mixing. For all Examples 1 through 7 and Comparative Examples 1 and 2, the compounds were visually inspected after milling and melting point values (Tₘ) were measured for the blends according to the procedures described below under “Melting point, glass transition, and recrystallization of compounded samples” for a portion of each blended sample. For Example 1 and Comparative Example 1, no significant fibrillation was observed during mixing. The melting point values are included in Table 3 and Table 4. Visual inspection results are for Examples 2 through 7 and Comparative Example 2 are included in Table 4.

A portion of each of mill blends for Example 1, Comparative Example 1, and mill blends A through D was further compounded on the two-roll mill to incorporate Catalyst A, as indicated in Tables 3 and 5. Included in Table 3 are results for cure rheology measurements and plasma resistance measurements. Included in Table 4 are the results of modulus, appearance of milled sheets, results of cure rheology measurements, and results of composition set measurements. The procedures followed for modulus, cure rheology, plasma resistance, and compression set measurements are described below.

Melting Point, Glass Transition, and Recrystallization of Compounded Samples

Melting point (Tₘ) and glass transition temperature (T_{g}) were determined in accordance with ASTM D 793-01 and ASTM E 1356-98 by a TA Instruments differential scanning calorimetry DSC Q2000 under a nitrogen flow. A DSC scan was obtained from −85° C. to 350° C. at 10° C./min. scan rate. The first heat cycle started at −85° C. and was ramped to 350° C. at a 10° C./minute. The cooling cycle started at 350° C. and was cooled to −85° C. at 10° C./min. The second heat cycle started at −85° C. and was ramped to 350° C. at a 10° C./minute. A DSC thermogram was obtained from the second heat of a heat/cool/heat cycle to determine Tₘ. The peak or peaks of recrystallization temperature were obtained from the cooling scan after the first heat scan.

Inflection Point Temperature and Semi Crystalline Fluoropolymer Blend Ratio

Inflection point temperature was determined using a TGA (Thermogravimetry Analysis TGA Q500 by TA Instrument) from the derivative curve in accordance with ASTM E 1131-08. The sample size for the test was 10.0±1 mg. The sample was heated to 650° C. at a 10° C./minute under a nitrogen flow and then further heated to 800° C. at a 10° C./minute under air flow. The first derivative curve of the weight loss plotted against the temperature showed two maxima. The temperature at which the minimum between these two maxima occurred was taken as the inflection point that indicated the onset of the decomposition of the semi-crystalline fluoropolymer. Inflection points are shown in Table 3. The semi crystalline fluoropolymer blend ratio was determined from the weight loss curve as the ratio of weight lost at temperatures higher than the inflection point to the total weight loss for the sample, expressed as percentages. Semi crystalline fluoropolymer blend ratios are shown in Table 3.

The mill blends in the above examples and comparative examples were compounded as follows: 100 g of the blend with 1.1 g of Catalyst A were prepared using a 6 inch (15.24 cm) two roll mill. The compounds were characterized by measurement of modulus, visual observation of milled sheets, cure rheology, and compression set, according to the procedures described below.

Visual Inspection of Compounds

After mixing on the mill was complete, the blend was removed from the roll by cutting. The appearance of the resulting sheets was visually inspected. When fibrillation of the perfluoropolymer was observed during mixing, the surface appeared significantly rough. The visual observations for each sample are reported in Table 4.

Modulus of Compounded Samples and Frequency Sweep

Modulus at 100° C. was determined using a rheometer (RP A 2000 by Alpha technologies, Akron, Ohio) at a strain of 7% and a frequency sweep of 01, 2.0 and 20 Hz from the storage modulus (G′), which is obtained from ASTM 6204-07 Part A. The sample size for the test was 7.0±0.1 grams. Pre-conditioning step was done before modulus measurement at 0.5 Hz, 62.8% strain, and 100° C. for 5 minutes. Results are reported in Table 4.

Cure Rheology of Compounded Samples

The cure characteristics for Examples 1, A, B, C, and D Comparative example 1 were measured using an Alpha Technologies Rubber Process Analyzer with Moving Die Rheometer (MDR) mode under conditions corresponding to ASTM D5289-07. Cure rheology tests were carried out using uncured, compounded samples at 160° C. or 165° C., no pre-heat, 15 minutes or 12 minutes elapsed time, and a 0.5 degree arc. Both the minimum torque (M_{L}) and highest torque attained during a specified period of time when no plateau or maximum torque (M_{H}) was obtained were measured. Also measured were the time for the torque to increase 2 units above M_{L} (tₛ2), the time for the torque to reach a value equal to M_{L}+0.1(M_{H}−M_{L}), (t′10), the time for the torque to reach a value equal to M_{L}+0.5(M_{H}−M_{L}), (t′50), and the time for the torque to reach M_{L}+0.9(M_{H}−M_{L}), (t′90).

Visual Inspection of Compounds

After mixing on the mill was complete, the blend was removed from the roll by cutting. The appearance of the resulting sheets was visually inspected. The visual appearance of the entire sheet was reported as either appearing smooth or rough. The presence of fibrillation was determined by visually inspecting the sheet for the appearance of none, little, or significant amount of white lines in the sheet. The visual observations for each sample are reported in Table 3.

Molded O-Rings and Compression Set Test

O-rings (214, AMS AS568) were mold at 160° C. for 15 minutes or 165° C. for 10 minutes. The press-cured O-rings were post-cured at the following step cure procedure.

The first step cure started at room temperature and was ramped to 150° C. for 2 hours. It was held at 150° C. for 7 hours. The second step cure started at 150° C. and was ramped to 300° C. or 325° C. for 2 hours. It was held at 300° C. or 325° C. for 8 hours. Then cooling step started at 300° C. or 325° C. and was cooled to room temperature for 2 hours.

The post-cured O-rings were tested for compression set for 70 hours at 300° C. in accordance with ASTM D 395-03 Method B and ASTM D 1414-94 with 25% initial deflection. Results are reported as percentages.

Plasma Tests

The post-cured O-rings were tested for plasma resistance using Plasma Pod (available from JLS Designs Ltd, UK). One half of the O-ring was placed in the plasma chamber at a center between the radio frequency electrodes and the plasma irradiation was carried out under a total 30 sccm gas flow of oxygen only or oxygen and CF₄ with 9:1 ratio. The pressure was 225 mTorr and RF power was 200 W. After one hour exposure to plasma, the weight loss was measured and calculated using the equation below. The plasma testing results are summarized in

Table 2.

$$Weight loss ( \% ) = \frac{\begin{matrix}weight before plasma exposure - \\ weight after plasma exposure\end{matrix}}{weight before plasma exposure} \times 100$$

TABLE 2

| | | Co. |
|---|---|---|
| | Ex. | Ex. |
| | 1 | 1 |
| PFE A | 100 | 100 |
| TFM 2001Z | 25 | |
| PFA 6503NAZ | | 25 |
| Catalyst A | 1.1 | 1.1 |
| MDR | | |
| Time (min) | 12 | 12 |
| Temperature (° C.) | 165 | 165 |
| ML (dNm) | 2.8 | 2.3 |
| MH (dNm) | 10.0 | 9.9 |
| D torque (dNm) | 7.2 | 7.6 |
| ts2 (min) | 1.7 | 1.8 |
| t50 (min) | 2.5 | 2.6 |
| t90 (min) | 6.7 | 7.2 |
| tan d ML | 0.8 | 0.8 |
| tan d MH | 0.165 | 0.160 |
| Press cure time (min) | 10 | 10 |
| Press cure temp. (° C.) | 165 | 165 |
| DSC | | |
| T_{g} (° C.) | −0.8 | −2.7 |
| Tₘ (° C.) | 322 | 307 |
| ΔH (J/g) | 4.5 | 4 |
| Plasma resistance | | |
| CF₄: 3 Sccm/O₂: 27 sccm, | | |
| 300 W, 225 mTorr | | |
| weight loss after 1 hour (%) | 6.2 | 7.0 |
| O₂: 30 sccm, 200 W, 225 | | |
| mTorr | | |
| weight loss (%) 1.5 hour | 6.0 | 6.1 |

TABLE 3

| Example or | | | | | | | |
|---|---|---|---|---|---|---|---|
| Comparative Example | EX-2 | EX-3 | EX-4 | CE-2 | EX-5 | EX-6 | EX-7 |
| Mill Blend designation | A | B | C | D | E | F | G |
| Formulation (phr) | | | | | | | |
| PFE A | 100 | 100 | 100 | 100 | | | |
| PFE B | | | | | 80 | 75 | 70 |
| Fluoropolymer A | 25 | | | | 20 | 25 | 30 |
| Fluoropolymer B | | 25 | | | | | |
| Fluoropolymer C | | | 25 | | | | |
| TF 2071 | | | | 25 | | | |
| Tm of the semi- | 323 | 328 | 321 | 326 | 323 | 323 | 323 |
| crystalline | | | | | | | |
| fluoropolymer (° C.) | | | | | | | |
| Recrystallization (° C.) | 306 | 303 | 306 | 314 | 306 | 306 | 306 |
| DSC of the dry blend | | | | | | | |
| Tₘ (° C.) | 316 | 318 | 322 | 327 | 316 | 316 | 317 |
| Re-crystallization | 264 | 304 | 305 | 314 | 270 | 268 | 269 |
| temperature peak(s) | 280 | | | | 278 | 276 | 295 |
| (° C.) | 297 | | | | 296 | | |
| TGA | | | | | | | |
| Inflection point (° C.) | 554 | 556 | 557 | 556 | 554 | 552 | 551 |
| Semi crystalline | 19 | 19 | 20 | 19 | 19 | 24 | 29 |
| fluoropolymer blend | | | | | | | |
| ratio (%) | | | | | | | |

TABLE 4

| | EX-2 | EX-3 | EX-4 | CE-2 |
|---|---|---|---|---|
| Formulation (phr) | | | | |
| Mill blend A | 125 | | | |
| Mill blend B | | 125 | | |
| Mill blend C | | | 125 | |
| Mill blend D | | | | 125 |
| Catalyst A | 1.1 | 1.1 | 1.1 | 1.1 |
| Frequency sweep @100° C. | | | | |
| 0.1 Hz (KPa) | 418 | 487 | 445 | 602 |
| 1 Hz (KPa) | 1052 | 1021 | 980 | 1157 |
| 20 Hz (KPa) | 1475 | 1408 | 1367 | 1577 |
| Appearance of milled sheet | smooth | smooth | smooth | rough |
| Fibrillation | no | no | little | significant |
| MDR (15 min@160° C.) | | | | |
| ML (dNm) | 3.1 | 3.3 | 3.1 | 4.6 |
| MH (dNm) | 11.4 | 10.7 | 10.3 | 11.2 |
| delta torque (dNm) | 8.3 | 7.4 | 7.3 | 6.6 |
| ts2 (min) | 2.2 | 2.3 | 2.3 | 2.4 |
| t50 (min) | 3.5 | 3.3 | 3.4 | 3.3 |
| t90 (min) | 9.6 | 9.1 | 9.3 | 9.3 |
| tan d ML | 0.9 | 0.8 | 0.8 | 0.70 |
| tan d MH | 0.144 | 0.178 | 0.161 | 0.218 |
| Compression Set at 70 | | | | |
| hours @300° C. | | | | |
| 25% deflection | 67 | 65 | Not run | — |

— unable to mold uniform thickness O-rings

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A dry powder blend comprising (i) an amorphous perfluoropolymer comprising a cure site selected from the group consisting of —CN, —I, and —Br, and (ii) a plurality of semi crystalline fluoropolymer particles, wherein the semi crystalline fluoropolymer particles comprise a tetrafluoroethylene copolymer comprising no more than 1 wt % of at least one additional fluorinated monomer as determined by Fourier Transform-Infrared spectrometry, wherein the semi crystalline fluoropolymer particles (i) have an melt flow index (372° C. with 2.16 kg) of less than 50 g/10 min or (ii) are not melt processible and have an standard specific gravity of less than 2.200.

2. The dry blend of claim 1, wherein the blend has a melting temperature and the melting temperature of the blend is at least 3° C. lower than the melting point of the semi crystalline fluoropolymer particles.

3. The dry blend of claim 1, wherein the melting temperature of the blend is greater than 320° C. and less than 329° C.

4. (canceled)

5. The dry blend of claim 1, wherein the dry powder blend has a decomposition temperature, and the decomposition temperature at least 500° C. and at most 510° C.

6. The dry blend of claim 1, wherein the dry powder blend has at least one recrystallization point, and the at least one recrystallization point is less than 310° C.

7. The dry blend of claim 1, wherein the dry powder blend comprises at least 10 to at most 30 wt % of the semi crystalline fluoropolymer particles.

8. The dry blend of claim 1, wherein the amount of the at least one additional fluorinated monomer is not more than 0.1 wt % in the tetrafluoroethylene copolymer.

9. The dry blend of claim 1 wherein the at least one additional fluorinated monomer is selected from at least one of hexafluoropropylene, and an unsaturated perfluorinated ether selected from the general formula:
R_{f}—O—(CF₂)ₘCF=CF₂
wherein in is 0 or 1 and Rf represents a perfluoroalkyl residue containing from at least 1 carbon atoms which may be interrupted by at least one in-chain oxygen atom.

10. The dry blend of claim 1 wherein the tetrafluoroethylene copolymer is a core-shell particle.

11. The dry blend of claim 1 wherein the amorphous perfluoropolymer has a glass transition temperature of less than 10° C.

12. The dry blend of claim 1, wherein the amorphous perfluoropolymer is derived from a perfluoroolefin and an unsaturated perfluorinated ether selected from the general formula:
R_{f}—O—(CF₂)ₘCF=CF₂
wherein in is 0 or 1 and Rf represents a perfluoroalkyl residue containing from at least 1 carbon atoms which may be interrupted by at least one in-chain oxygen atom.

13. The dry powder blend of claim 12, wherein the perfluoroolefin is tetrafluoroethylene, hexafluoropropylene, or combinations thereof.

14. (canceled)

15. The dry blend of claim 1, wherein the amorphous perfluoropolymer comprises a cure site selected from at least one of bromine, and iodin.

16. The dry blend of claim 1, wherein the second fluorinated monomer is a nitrile-containing perfluorinated vinyl ether.

17. The dry blend of claim 1, wherein the powder blend comprises less than 500 ppb of C8-C14 fluorinated alkanoic acids.

18. A curable perfluoropolymer composition comprising a homogeneous dry blend of (i) an amorphous perfluoropolymer and (ii) semi crystalline fluoropolymer particles, wherein the semi crystalline fluoropolymer particles comprise a tertrafluoroethylene copolymer comprising no more than 1 wt % of at least one additional fluorinated monomer as determined by Fourier Transform-Infrared spectrometry, wherein the semi crystalline fluoropolymer particles (i) have a melt flow index (372° C. with 2.16 kg) of less than 50 g/10 min or (ii) are not melt processible and have an standard specific gravity of less than 2.200.

19. A cured perfluoroelastomer comprising a perfluoropolymer filled with semi crystalline fluoropolymer particles, wherein the semi crystalline fluoropolymer particles comprise a tertrafluoroethylene copolymer comprising no more than 1 wt % of at least one additional fluorinated monomer as determined by Fourier Transform-Infrared spectrometry, wherein the semi crystalline fluoropolymer particles (i) have a melt flow index (372° C. with 2.16 kg) of less than 50 g/10 min or (ii) are not melt processible and have a standard specific gravity of less than 2.200.

20. A method of making a fluoroelastomer article, the method comprising: providing the dry blend of any one of claims 1 to 18, shaping the dry blend; and curing the shaped dry blend to form the fluoroelastomer article.

21. The method of claim 20, wherein curing is performed at a temperature higher than 300° C.

22. The method of claim 21, wherein curing is performed at a temperature higher than the melting point of semi crystalline fluoropolymer particles.

23. (canceled)
